(19) United States
(12) Patent Application Publication
(10) Pub. No.: US 2010/0296802 A1
(43) Pub. Date: Nov. 25, 2010

(54) Self-zooming camera

(76) Inventor: John Andrew Davies, Portland, OR (US)

Correspondence Address: John Andrew Davies, 1885 SW River Square, Portland, OR, 97201, US

(21) Appl. No.: 12/459,667

(22) Filed: Jul. 7, 2009

Related U.S. Application Data
(60) Provisional application No. 61/216,734, filed on May 21, 2009.

(51) Int. Cl. G03B 17/00

(52) U.S. Cl. 396/77

(57) ABSTRACT

The Self-Zooming Camera uses proximity detectors and/or motion detectors in the camera to detect the position of the camera/recording device relative to the operator's eye or face. At closest viewable distance to the face (approx. 6 inches), the zoom lens operates at it's widest angle or user-specified widest angle setting. At furthest extent from the face (arm's length, approximately 2 feet), the camera zooms to its longest telephoto extent or user-specified longest zoom setting.

The Self-Zooming Camera allows simple and creative zoom operation of a camera, video recorder or mobile device with camera without using buttons or zoom/focus pulling—replacing traditional controls with intuitive gesture or camera motion.

### FIELD OF THE INVENTION

Digital Photography, commercial photography, consumer electronics, videography.

### BACKGROUND OF THE INVENTION

Digital photography and photography in general has made many advances in recent years. With the development and incorporation of proximity sensors, motion sensors, touch screens and various other techniques, all with the aim of making the the camera itself is becoming more and more intuitive and user-friendly.

Many cameras now feature automation of some kind, whether exposure, color balance, flash, film speed setting or similar. Zoom lenses can now also be controlled in a much simpler manner, particularly on compact or ‘point-and-shoot’ cameras and mobile devices, replacing traditional zoom rings (mechanical lens rings similar to focus rings which when turned, rearrange lens elements to alter the users' field of view) with simple sliders (touch screen or button-based) where the user pushes to the left or right or up and down to achieve zooming of the lens elements (known as ‘optical zooming’) or in some cases ‘digital zooming’ which is where the camera's imaging sensor changes the field of view ‘approximating’ a zoom view rather than moving lens elements.

In the market, there exist many cameras, mobile devices which include cameras and video cameras that utilize some or all of the above mention items (optical zooms, digital zooms, motion sensors and proximity sensors), but none offer a simple button-free or hand-free method to effectively operate the zoom lens.

### BRIEF SUMMARY OF THE INVENTION

The Self-Zooming Camera uses proximity detectors and/or motion detectors in the camera to detect the position of the camera/recording device relative to the operator's eye or face. At closest viewable distance to the face (approx. 6 inches), the zoom lens operates at it's widest angle or user-specified widest angle setting. At furthest extent from the face (arm's length, approximately 2 feet), the camera zooms to its longest telephoto extent or user-specified longest zoom setting.

The proximity sensors may be calibrated to approximate operators' eye-view through the framing of the camera's LCD display or it may be ‘sensitized’ to user preferences to allow full zoom control simply by moving the camera toward and away from the face through either the full range of camera zoom or through a preset range. With the use of motion detectors, the system could zoom a pre-selected amount by simple detection of forward motion, and, likewise, zoom out if backward motion is detected—this approach would provide an adequate back up to the self-zooming proximity detectors in low or difficult lighting situations.

This method could also be used to control focus, aperture and shutter speed if programmed that way.

### A DESCRIPTION OF THE DRAWINGS

FIGS. 1 and 2 show the camera or recording device (c.), user (4.) and general method of use of the self-zooming camera.

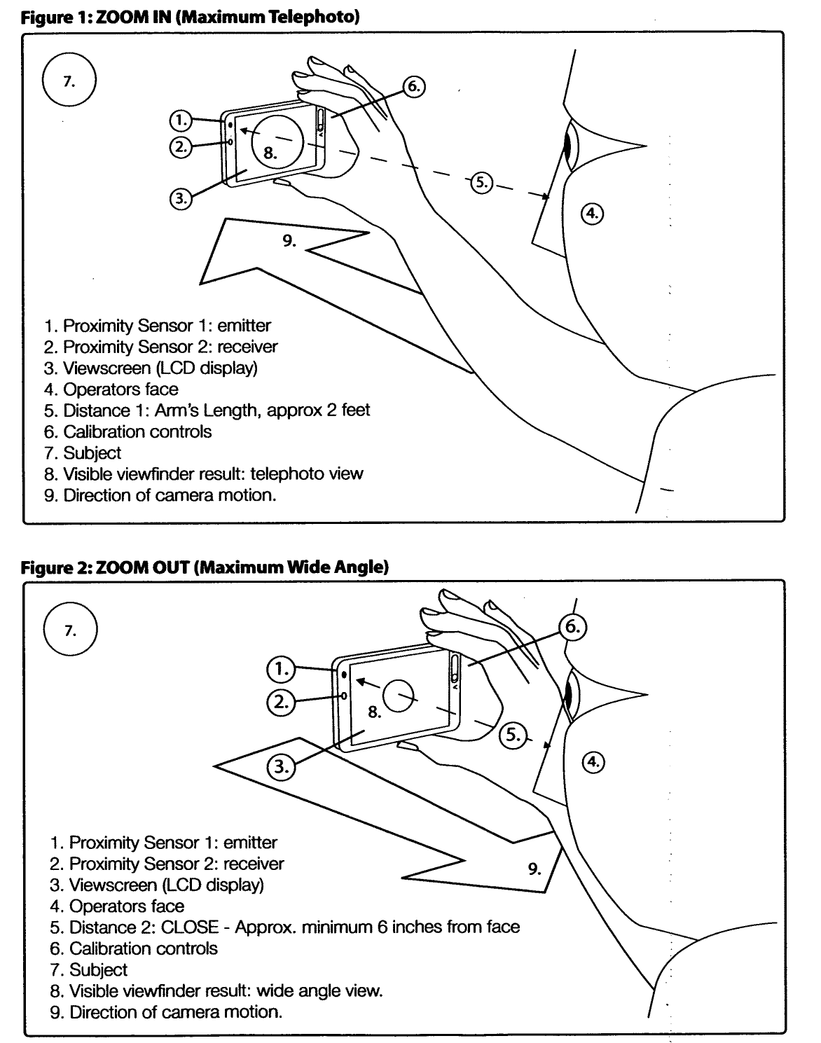

In FIG. 1., the user moves the camera (c.) away from his face (4.), thereby increasing the distance of the camera from the position of his eye or face. The proximity sensor (1.) detects the increased distance and adjusts the focal length of the lens either digitally or optically to a corresponding focal length—in this case ‘zoomed in’ the results of which (8.) are displayed on the LCD viewscreen (3.)

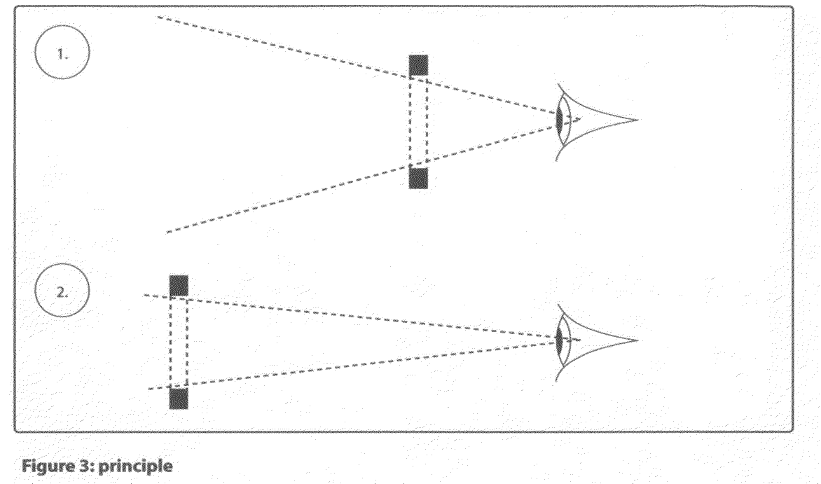

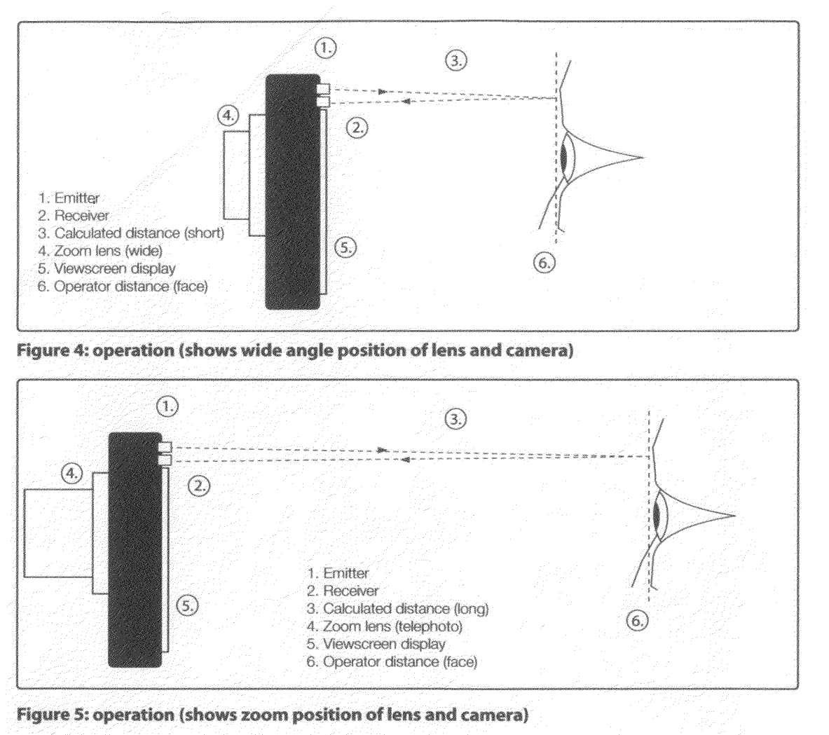

In FIG. 2., the user moves the camera (c.) closer to his face (4.), thereby decreasing the distance of the camera from the position of his eye or face. The proximity sensor (1.) detects the decreased distance and adjusts the focal length of the lens either digitally or optically to a corresponding focal length—in this case ‘zoomed out’ the results of which (8.) are displayed on the LCD viewscreen (3.)

Likewise, if motion sensors replaced or supplemented the proximity sensors, the forward motion (f1-9.) of the camera would result in the lens or digital zoom zooming in to the subject (narrowing field of view) and the rearward motion of the camera (f2-9.) would then result in the lens or digital zoom zooming out (widening the field of view).

FIG. 3 demonstrates: (1.) the approximate field of view through a viewfinder or frame (consider a simple four-sided window with a frame and clear glass inside) when the viewfinder or frame is close to the eye: the eye sees a wide angle of view and (2.) the approximate field of view through same viewfinder or frame when the viewfinder or frame is held further away from the eye: the eye sees a narrow angle of view.

This is the concept behind the Self-Zooming Camera control method: The closer that the camera/recording device/camera-equipped mobile device is held in relation to the operators eye, the wider the field of view that is electronically displayed on the viewfinder (the lens zooms to its wide angle setting). When the camera is moved away from the eye, the lens zooms in, showing a telephoto or narrower, field of view to approximate what the eye might see through the frame (FIG. 3).

This operation feels natural, intuitive to the user, because it is what the eye expects to see, a tactile advantage over less intuitive knobs, dials and rings.

FIGS. 4 and 5 show a side view of the method in operation. The proximity sensor emitter (1) sends out a beam of infrared light from the direct rear of the camera or recording device constantly, whenever the device is switched on. The proximity sensor receiver (2), receives the beam reflected back from operator position (face area (6)) and calculates the time of light travel in order to determine distance.

If that calculated time is determined to be short (camera is close to operator position or face), the zoom lens (4) would stay at its default or wide angle position or, if at measurement interval the zoom lens was at telephoto position, it would return to wide angle position. If that calculated time is determined to be longer (camera is further away from operator face position (6)), the camera lens (4) zooms to a telephoto or zoom position.

The camera/operator distance and position of lens relationship would be set by predetermined increments in software—selectable by the user from factory default settings.

### DETAILED DESCRIPTION OF THE INVENTION

The System.

The Self-Zooming Camera utilizes proximity detectors and/or motion detectors in the camera or recording device to detect the position of the camera/recording device relative to the operator's eye or face—the further away from the operator's face; the more the camera lens is zoomed in (narrowing angle of view); the closer the camera is to the operator's face, the wider the angle of view from the lens. This approach to control is based upon the concept of approximating what the human eye sees when looking through a frame or viewfinder.

The camera or mobile device require the use of Infrared proximity detection (diffuse reflective sensing) to send light from camera to operator's face, and measure time on return to camera. It may also be possible using more accurate ultrasonic sensors, but the short range and limited application mean that the simplest measurement sensors should suffice. The maximum/minimum operating distance for the camera is a ‘comfortable’ arm's length, primarily because a: that is the only practical distance that should be needed and b: the camera's design can be calibrated to allow large or or small zoom increments based on minimal camera position changing.

### Programming and Calibration.

Factory or default settings for the camera/recording device would be set as follows:
1. Minimum distance to equal widest angle of view: approximately 6 inches
2. Maximum distance to equal longest telephoto or lens zoom: approximately 20 inches (or two feet).

Minimum distance is determined by practicality: the device viewscreen would be hard to see at a distance any closer than six inches from the user face. Likewise, maximum distance is also determined by the physical limitation of arm's length and eyesight reach to be approximately twenty inches or two feet from the operator's position.

Calibration of the software is designed to make the composition process of zooming in and out using the motion of the camera rather than buttons or dials as intuitive or natural as reading or viewing images in a frame. The operator can set their own minimum and maximum distances based on their ‘comfort zone.’ desired or practical range of maneuverability.

The operator can use setup of the software to set their favorite or most optimum camera/eye distance for wide angle and for zoom, with the increments in-between measured and determined by the software setup. Some users may prefer the novelty of a full wide range of movement (from minimum 6 in. to maximum 20 in.) to operate the zoom features. Others may desire a much shorter operating zone and the software allows the operator to do just that; setting, for example, a short range of camera motion to allow full zoom variation with minimal motion and effort.

In short, this control method allows single handed intuitive operation without the need to reach for focus/zoom rings or buttons and dials. It allows for more natural composition, faster operation and more fun in device operation for the user.

Using the Motion Sensor (detection of camera forward or backward motion through the use of built-in accelerometer) option or approach (as a back up or alternative to the proximity detectors in low or difficult lighting situations), the software could simply zoom in when forward motion is detected (the motion of moving the camera away from the face) and zoom out when backward motion is detected (the motion of moving the camera closer to the face). This approach is not as accurate as the proximity approach, and requires simple presets for the zooming (in, standard and out (wide)), that could correspond to the camera's detected motion.

### The Method.

As illustrated in FIG. 2. (Principle), The human eye would see more of a subject when a viewfinder or frame is placed close to the eye, as opposed to the narrower field of view that is seen when same frame is moved further from the eye. This zoom lens control method requires a measurement of distance from the rear of the unit (recording device) to the user's position (or face).

To achieve this, this invention uses proximity sensors and motion sensors (or accelerometer) either alone or in combination to control the settings of the zoom lens (the recording device's field of view).

### The Elements Required.

Compact digital camera, video camera or camera-equipped mobile device (such as smart phone)

LCD viewfinder display

Zoom lens (either digital or optical)

Proximity sensor and or motion sensor/accelerometer

Distance/Zoom detection and calibration software

Electronic Zoom lens control (motor-driven for optical zooms, software-based for digital zooms)

The invention claimed is:

1. A method for controlling camera/image recording device lens field of view by measuring distance from operator.

2. The use of proximity sensors for measuring distance from camera/image recording device to operator as a means of controlling camera/image recording device lens field of view (zoom in or out).

3. The use of motion sensing or accelerometer to detect forward or backward motion of a camera or image recording device and control said device lens' field of view accordingly (zoom in or out).
